(19) United States
(12) Patent Application Publication
(10) Pub. No.: US 2026/0221535 A1
(43) Pub. Date: Jul. 30, 2026

(54) THERMAL REGULATION DEVICE, AND CHARGING DEVICE COMPRISING A THERMAL REGULATION DEVICE

(71) Applicant: VALEO SYSTEMES THERMIQUES, Le Mesnil-Saint-Denis (FR)

(72) Inventors: Roberto FERNANDEZ, Zaragoza (ES); Jean-Louis LANARD, Le Mesnil-Saint-Denis Cedex (FR); Philippe OGER, Le Mesnil- Saint-Denis Cedex (FR); Boris BARRE, Le Mesnil- Saint-Denis Cedex (FR); Jesus JIMENEZ, Zaragoza (ES)

(73) Assignee: VALEO SYSTEMES THERMIQUES, Le Mesnil-Saint-Denis (FR)

(21) Appl. No.: 19/159,063

(22) PCT Filed: Feb. 28, 2024
(86) PCT No.: PCT/EP2024/055121

§ 371 Date: Aug. 22, 2025

(30) Foreign Application Priority Data
Mar. 1, 2023 (FR) FR2301884

(51) Int. Cl. H01M 10/6556; B60L 50/64; H01M 10/613; H01M 10/625; H01M 10/656

(52) U.S. Cl. CPC H01M 10/6556; H01M 10/613; H01M 10/625; H01M 10/656; B60L 50/64; H01M 2220/20

(57) ABSTRACT

A thermal regulation device for an electrical component that is liable to release heat during operation. The device includes a first plate and a second plate, which is assembled with the first plate, each being delimited by edges, in order to form together a plurality of circulation channels for a heat transfer fluid. The plurality of channels define a channel zone, at least one of the plates is pressed in order to form a portion of the walls of the channels, the assembly of the two plates being carried out by laser welding at the walls of the channels. A zone defining at least partially the perimeter of the channel zone includes an assembly mechanism different from transmission laser welding, the different assembly mechanism is selected from among filler wire laser welding, adhesive bonding, friction stir welding, or a combination thereof.

The present invention relates to a thermal regulation device, in particular a cooling device, in particular for an electrical component that is liable to release heat during operation, in particular to a device for cooling at least one battery or battery cells of a vehicle, for example a motor vehicle.

The vehicle may be a land vehicle, a marine vehicle or an aerial vehicle.

The components to which the present invention relates can be electrical energy storage elements, in particular battery elements, or power electronics elements, for example but not limited to semiconductors such as diodes or transistors. They could also be components of computer servers.

The electrical or electronic systems, for example electrical energy storage devices in a motor vehicle or computer servers, may be subject to significant constraints because of a need to supply an element that requires a large amount of energy or because of the need to perform significant processing of information in a very short time. Thus, when these electrical or electronic systems are heavily used, they are liable to release a large amount of heat and therefore reach high temperatures, which reduce the service life of said electrical or electronic systems.

In order to limit the temperature of the electrical or electronic systems, it is known practice to provide cooling devices associated with these systems. Such cooling devices are arranged in the vicinity of the parts of the electrical or electronic system that release heat, and a cooling fluid flows through them, the temperature of which makes it possible to exchange heat with these parts and to cool them. These cooling devices may in particular be plate devices, which are obtained by assembling at least two pressed plates that are welded to one another in order to form channels between said plates, said channels making it possible for the cooling fluid to circulate.

The invention notably relates to plate heat exchangers intended for the circulation of a refrigerant fluid for cooling the batteries of electric or hybrid vehicles.

Industrially, these exchangers are generally made of metal and are assembled by brazing.

Although currently very widespread in the industry, the brazing method has disadvantages, in particular the carbon footprint of such a manufacturing method, so that alternative solutions for joining two plates have gradually been proposed with the aim of reducing in particular the electricity consumption and therefore the emissions generated indirectly by such a method, one such solution being to assemble the two plates by welding, in particular by laser welding.

The laser welding method has several advantages. Specifically, such a method is less energy-intensive and less polluting than welding by brazing. It makes it possible to produce a reliable joint without leaks, particularly in straight lines. However, heat exchangers comprise other types of paths, such as bends, loops and other complex paths.

These paths, in which the direction of the laser beam changes, are more sensitive to welding defects such as cracks, which may lead to leaks.

There is therefore a need to obtain heat exchangers that are robust and free from leaks, and to do so with the aid of a more eco-friendly, rapid and reliable method.

It is an aim of the present invention to at least partially overcome one or more of the aforementioned drawbacks by providing a heat exchanger, manufactured using a combination of several assembly technologies, in order to satisfy the requirements of sealing and mechanical strength, while reducing the electricity consumption and the production of pollutants compared to a brazing method.

The invention thus relates to a thermal regulation device, in particular a cooling device, for an electrical component that is liable to release heat during operation, in particular for an electrical energy storage module, this device having a first plate and a second plate, which is assembled with the first plate, each being delimited by edges, in order to form together a plurality of circulation channels for a heat transfer fluid, in particular a refrigerant fluid, the plurality of channels defining a channel zone, at least one of the plates being pressed in order to form a portion of the walls of the channels, the assembly of the two plates being carried out by transmission laser welding at the walls of the channels, the device being characterized in that a zone defining at least partially the perimeter of the channel zone comprises an assembly means different from transmission laser welding, the different assembly means is selected from among filler wire laser welding, adhesive bonding, friction stir welding, or a combination thereof.

“Assembled by laser welding at the channel zone” means that the two plates are attached to one another at the channels in such a way as to allow heat transfer fluid to circulate between the two parts.

Advantageously, this assembly method, which is different from transmission laser welding, makes it possible to improve the mechanical strength and reliability of the device while facilitating manufacturing by overcoming the disadvantages of transmission laser welding.

The charging device may also include one or more of the features described below, separately or in combination.

According to a particular feature of the invention, the zone comprising an assembly means (8) defines the entire perimeter of the channel zone.

According to a particular feature of the invention, at least one channel wall defines the perimeter of the channel zone. “Perimeter of the channel zone” thus means the channel wall furthest from the center of the device, and in particular the portion of the channel wall of a plate which is joined to the other plate.

According to a particular feature of the invention, the perimeter of the channel zone, preferably the at least one channel wall defining at least a portion of the perimeter of the channel zone, comprises a weld formed by friction stir welding or an adhesively bonded join.

According to a particular feature of the invention, the perimeter of the channel zone, preferably the at least one channel wall defining at least a portion of the perimeter of the channel zone, comprises a weld formed by friction stir welding.

According to a particular feature of the invention, the perimeter of the channel zone, preferably the at least one channel wall defining at least a portion of the perimeter of the channel zone, comprises an adhesively bonded join.

According to a particular feature of the invention, the perimeter of the channel zone, preferably the at least one pressed channel wall defining at least a portion of the perimeter of the channel zone, defines the entire perimeter of the channel zone and forms a sealing channel, the sealing channel comprising glue forming a seal.

According to a particular feature of the invention, the device comprises an additional weld, preferably by laser welding, bordering the outer side of the join of the perimeter of the channel zone by the different assembly means.

According to a particular feature of the invention, the additional weld, preferably by laser welding, joins at least the edges of at least one plate to the other plate.

The invention also provides a method for assembling two plates in order to obtain a thermal regulation device, in particular a cooling device, for an electrical component that is liable to release heat during operation, in particular for an electrical energy storage module, the method being characterized in that it comprises the following steps,
providing two plates, each delimited by edges, at least one of the plates being pressed in order to form a portion of the walls of the channels, in such a way as to form, together with the other plate, a plurality of circulation channels for a heat transfer fluid, in particular a refrigerant fluid, the plurality of channels defining a channel zone,
laser welding, preferably transmission laser welding, the two plates at the walls between the channels in contact with the second plate to form the channel zone,
then joining the perimeter of the channel zone of one plate to the other plate by an assembly means different from transmission laser welding, preferably by joining at least one channel wall defining said perimeter.

According to a particular feature of the invention, the method further comprises a third step of joining, by an additional weld, preferably by laser welding, surrounding the join of the perimeter of the channel zone by the different assembly means, in particular in such a way as to weld edges of at least one of the two plates to the other plate, preferably by laser welding.

According to a particular feature of the invention, the method further comprises a step of introducing glue that forms a seal in a pressed channel wall defining the entire perimeter of the channel zone and forming a sealing channel, in such a way that the glue is compressed by the two plates during their assembly, in particular followed by a step of heat treating the glue in the pressed wall once the plates of the device have been assembled and said glue has been compressed.

According to a particular feature of the invention, the method further comprises a step of heat treating the glue in the pressed wall once the plates of the device have been assembled and said glue has been compressed.

### DETAILED DESCRIPTION OF THE FIGURES

Other features and advantages of the invention will become clearer on reading the following description, which is provided by way of non-limiting illustrative example, and from the accompanying drawings, in which:

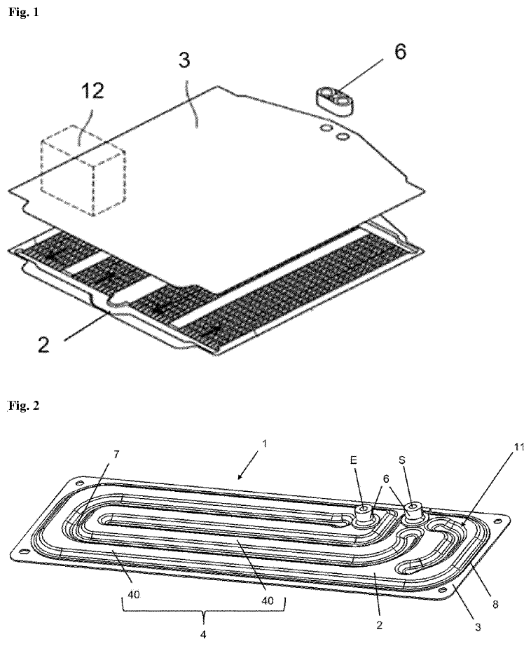

FIG. 1 schematically and partially illustrates a cooling device according to the prior art;

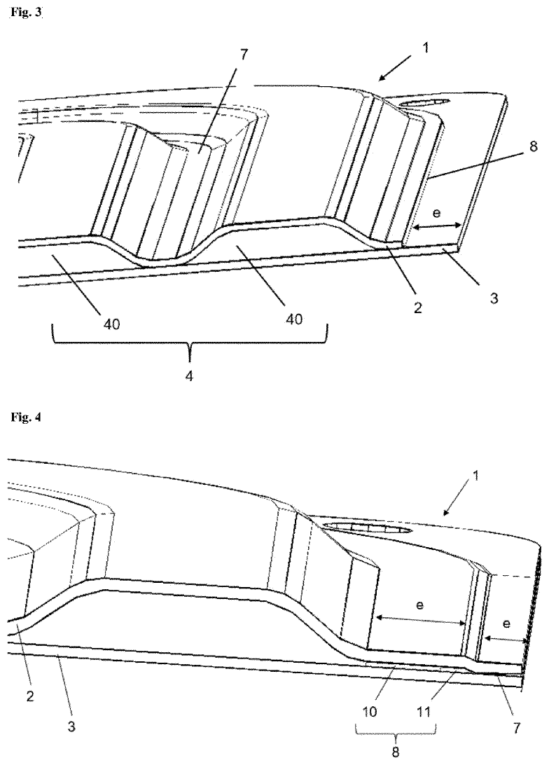

FIG. 2 schematically and partially illustrates a device according to a first embodiment of the invention in a perspective view;

FIG. 3 schematically and partially illustrates a detail of the device according to a second embodiment of the invention in a sectional view,

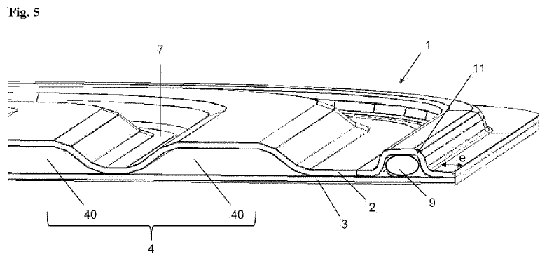

FIG. 4 schematically and partially illustrates a detail of the device according to a third embodiment of the invention in a sectional view;

FIG. 5 schematically and partially illustrates a detail of the device according to a fourth embodiment of the invention in a sectional view.

### THERMAL REGULATION DEVICE

The invention relates in particular to the thermal regulation device 3 described in more detail below. It comprises a thermal regulation device, in particular a cooling device, for an electrical component (2) that is liable to release heat during operation, in particular for an electrical energy storage module, this device having a first plate (2) and a second plate (3), which is assembled with the first plate, each being delimited by edges, in order to form together a plurality of circulation channels (5) for a heat transfer fluid, in particular a refrigerant fluid, the plurality of channels defining a channel zone (6), at least one of the plates being pressed in order to form a portion of the walls of the channels, the assembly of the two plates being carried out by transmission laser welding (7) at the walls of the channels, the device being characterized in that a zone defining at least partially the perimeter of the channel zone comprises an assembly means (8) different from transmission laser welding (7), the different assembly means (8) is selected from among filler wire laser welding, adhesive bonding, friction stir welding, or a combination thereof.

Minor communication leaks between the channels may be accepted because there is no loss of fluid to the exterior of the cooler, only an insignificant reduction in thermal uniformity at the surface of the battery. External leaks, regardless of their location, are not acceptable. One of the weaknesses of transmission laser welding is that it requires perfect contact between the surfaces to be welded.

The welding of the battery typically takes place from the interior of the cooler toward the exterior of the cooler, in order to be able to compensate for the expansions and deformations of the plates that are due to the preceding welds. This means that the surface of the plates at the perimeter of the channel may be deformed, or it is difficult to keep the two plates in contact. This increases the risk of leaks.

Mechanical constraints relating to battery coolers are increasing in number, and the mechanical behavior of the cooler has become a major issue.

One of the internal requirements is to keep the cooler manufacturing cycle time as short as possible, and therefore the join between the channels is in all cases made by transmission laser welding. The invention is applied to the perimeter of the plate or in specific zones. The advantage of the present invention is therefore to retain the advantages of transmission laser welding while overcoming its disadvantages.

The charging device may also include one or more of the features described below, separately or in combination.

The dimensions of the weld bead may be between 0.5 mm and 1.5 mm, preferably 0.75 mm and 1.25 mm.

The location of the join connecting the edges of one plate to the other plate is contingent on its position with respect to said edges, and depends on the position of the edges of the channels with respect to the edges of the flat plate. This distance between the join and the edge of the closest plate may vary from 0 to 5 cm, preferably from 0.1 cm to 3 cm, more preferentially from 0.1 cm to 1 cm.

It is to be understood here that the “edges” of the plate may be flat or pressed.

It is to be understood that fillet joint welding means welding without supplying material between the edge of one plate, preferably the pressed plate, and a flat zone of the other plate, preferably the upper flat plate. The laser is used to melt the material of the plates in order to produce the weld between them.

In the case of filler wire welding, the welding may be carried out with the same position of the plates, for example, but a filler wire is melted in order to supply the material that will form the weld bead.

In some embodiments, one of the plates has a deformation forming a fold toward the second plate, for example a raised edge. This advantageously makes it possible to reduce the risks of dust, debris or moisture being able to get in between the two plates.

It also advantageously makes it possible to reduce the effects of the deformations that are due to the laser welding join produced in the channel zone.

The deformation of the first pressed plate in order to form the channels is generally carried out by pressing with deformation. The length of the deformation in the direction of the second plate, to which the first plate is intended to be joined, should not exceed the thickness of said second plate. When the plates are being joined, the laser welding creates stresses, for which reason it is advantageous to have solid external welds.

In some embodiments, the laser welding takes place from the interior of the plate, for instance the center, toward the exterior, in order to be able to optimally manage said stresses created by the deformation then welding of the plates.

The glue may be selected from among types of glue such as PU (polyurethane), epoxy or methacrylate.

In some embodiments, the glue is crosslinked, for example by heat treatment, following its application in the device, the glue being made of EPDM, NBR or FKM.

In some embodiments, transmission laser welding is first carried out between the channels, followed by implementation of the additional second assembly means, such as friction stir welding on the perimeter of the plate.

Friction stir welding is a solid-state welding method which consists in assembling two parts while bringing them into a paste-like state by using a rotating pin. One example of such a method consists of a cylindrically shaped tool having a shoulder and a coaxial pin that rotates at a constant speed on the contact line between the parts to be welded, so as to cause “softening” of the materials, which become paste-like. The tool then penetrates into the plane of the joint and intimately mixes the materials. Complete assembly is obtained as the tool advances and progressively covers the entire zone that is to be welded. The maximum temperatures reached during the method are below the melting temperature of the material: the friction stir welding method is therefore a solid-state welding method.

In some embodiments, the device comprises a welding track that at least partially delimits the fluid circulation zone, and at least one weld bead, corresponding for example to the end of the welding track, is produced in contact with the welding track at least at one point of contact, the welding track and the weld bead having a different curvature with respect to one another at said point of contact.

By virtue of using a weld bead, the sealing of the cooling device is reliably ensured, and the stopping of the laser beam that carries out the welding does not affect the sealing of the cooling device. As will be described below, the weld bead may thus involve an additional welding operation which surrounds one end of the welding track and therefore ensures sealing around a zone potentially having leaks, which is formed by the end of the welding track, or it may involve extending the welding track in order to offset the risk of leakage, potentially due to the stopping of the laser beam, into a zone that is not problematic because it is far away from the fluid circulation zone.

In some embodiments, the weld bead is established at least partially in contact with the welding track and constitutes an additional weld that reinforces the sealing of the cooling device. In other words, the weld bead redoubles the sealing of the cooling device by making the welding track sealed. Thus, the cooling fluid cannot flow through a potential welding track because the weld bead either closes the welding track, while surrounding a potential weak point within the welding track, or extends the welding track in order to offset this weak point. In both of these cases, the sealing is ensured and guaranteed by virtue of the different curvature of the weld bead with respect to the welding track at the point of contact between the weld bead and the welding track.

In some embodiments, the weld bead forms an extension of the welding track. In other words, the weld bead is made in continuity with the welding track and the point of contact between the welding track and the weld bead corresponds to the join between the end of the welding track and the start of the weld bead. It is in particular by virtue of this extension by the weld bead that the sealing of the cooling device is ensured.

As mentioned above, the curvature is different between the welding track and the weld bead. Thus, starting from the point of contact, the weld bead deviates from a path established by the welding track.

In some embodiments, the welding track has a closed profile, the weld bead having a free end at a distance from the closed profile of the welding track.

By way of example, the closed profile as defined by the welding track may correspond to the contour of the plates in order to prevent the cooling fluid from flowing out of the cooling device. In general, the closed profile may define a zone in which the cooling fluid should be contained, or conversely a zone into which the cooling fluid should not penetrate, for various reasons. For its part, the weld bead extends as far as the free end that deviates from the closed profile by virtue of the different curvature with respect to that of the welding track. This extension, which forms a free end, makes it possible to interrupt the laser beam at a distance from the end of the welding track and thus to avoid generating sealing defects as mentioned above.

FIG. 1 shows a prior art thermal regulation device 1, having a set of battery cells 12 to be cooled, for example aligned in two or more rows, which are in thermal contact with an upper plate 3 of the thermal regulation device 1. The device 1 comprises a pressed plate 2 and a flat plate 3, between which heat transfer fluid passes through channels. Most devices of this type are assembled by brazing in large furnaces, which presents several drawbacks, in particular the cost of such furnaces and their carbon footprint during operation.

FIG. 2 presents an example of an embodiment of the thermal regulation device 1 comprising a first plate 2, which is preferably pressed, and a second plate 3, which is preferably flat. The channels 40 of the channel zone 4 can be seen; they are configured to contain a heat transfer fluid which flows through said channels 40. One plate is attached to the other at the channel zone 4 by transmission laser welding, while an assembly means (8) different from transmission laser welding (7) joins one plate (2, 3) to the other plate (2, 3) at the perimeter of the channel zone.

In some embodiments, as shown by way of non-limiting example in FIG. 3, the pressed plate 2 and the flat plate 3 are joined by fillet joint laser welding, or by filler wire laser welding, at the edges of a plate, in this case the pressed plate 2.

Thus, in some embodiments, the pressed plate 2 and the flat plate 3 are joined by an assembly means (8) different from laser welding (7) at the edges of a plate, in this case the pressed plate 2, on another plate, in this case the flat plate 3, on a line at a distance from the edge of said flat plate 3.

The flat plate 3 thus extends beyond the edges of the other, pressed plate 2.

This advantageously makes possible to reduce the weight of the device, because the plate whose edges are attached to the other plate is smaller than the other plate. It furthermore makes it possible to use the larger plate as a screen for protecting the join from some of the impurities of the environment, in order to improve the corrosion resistance.

In some embodiments, the second plate extends beyond the edges of the first plate (2) by a length of at least 1 mm, preferably at least 1.5 mm.

This advantageously makes it possible, in particular, to reduce the weight of the device while benefiting from the protection against corrosion, and to do so optimally.

In some embodiments, as shown by way of non-limiting example in FIG. 4, one of the two plates comprises a pressed section 8 around the channel zone, for example the pressed plate 2.

Said pressed section 8 may thus comprise an adhesive element 10, for example glue, in order to ensure the join between the two plates and the sealing of the assembly.

In some embodiments (not shown), the device comprises an adhesive element 10, for example glue, without having an additional pressed section 8.

In some embodiments, as shown by way of non-limiting example in FIGS. 4 and 5, one of the two plates, for example the pressed plate 2, comprises, around the channel zone, a pressed section 11 forming the perimeter of the channel zone, the device comprising a seal 9 or an adhesive 10 forming a seal 9, compressed between the two plates (2, 3), the seal 9 being placed in the space between the two plates (2, 3) formed by the pressed section 11.

The pressed section 11 is preferably bordered on at least one side by an additional laser weld joining the two plates. Said join may be located between the seal 9 and the edge of at least one of the plates, and may for example be produced by transmission laser welding.

In some embodiments, the length e of the joining means 8 formed by a pressed section 11 comprising an adhesive 10 or a seal 9 and the length e of the additional laser weld located between the seal 9 and the edge of at least one of the plates are greater than 3 mm.

In some embodiments, the height of the seal 9 is at least 1.5 mm.

It is to be understood that the lengths e₁, e₂, e₃, e₄, e₅, and e₆ are measured at a given point in the direction perpendicular to the main direction in which it extends at this point.

In some embodiments, the height of the pressed section 11 is at least 3 mm.

The internal structure of the seal 9 may be modified after it has been placed in the pressed section 11, for example by heat treatment.

### LIST OF REFERENCE SIGNS

1. thermal regulation device
2. first plate, pressed
3. second plate, flat
4. channel zone
40. channel
5. deformation forming a fold
6. connectors
7. transmission laser weld
8. different assembly means
9. seal
10. adhesive
11. pressed section
12. element, storage device, electrical component
E. fluid inlet
S. fluid outlet

1. A thermal regulation device, in particular a cooling device, for an electrical component that is liable to release heat during operation, in particular for an electrical energy storage module, this device having a first plate and a second plate, which is assembled with the first plate, each being delimited by edges, in order to form together a plurality of circulation channels for a heat transfer fluid, in particular a refrigerant fluid, the plurality of channels defining a channel zone, at least one of the plates being pressed in order to form a portion of the walls of the channels, the assembly of the two plates being carried out by transmission laser welding at the walls of the channels,
the device being wherein a zone defining at least partially the perimeter of the channel zone comprises an assembly means different from transmission laser welding, the different assembly means is selected from among filler wire laser welding, adhesive bonding, friction stir welding, or a combination thereof.

2. The thermal regulation device as claimed in claim 1, wherein at least one channel wall defines the perimeter of the channel zone.

3. The thermal regulation device as claimed in claim 1, wherein the perimeter of the channel zone, preferably the at least one channel wall defining at least a portion of the perimeter of the channel zone, comprises a weld formed by friction stir welding.

4. The thermal regulation device as claimed in claim 1, wherein the perimeter of the channel zone, preferably the at least one channel wall defining at least a portion of the perimeter of the channel zone, comprises an adhesively bonded join.

5. The thermal regulation device as claimed in claim 1, wherein the perimeter of the channel zone, preferably the at least one pressed channel wall defining at least a portion of the perimeter of the channel zone, defines the entire perimeter of the channel zone and forms a sealing channel, the sealing channel comprising glue forming a seal.

6. The thermal regulation device as claimed in claim 1, wherein the device comprises an additional weld, preferably by laser welding, bordering the outer side of the join of the perimeter of the channel zone by the different assembly means.

7. The thermal regulation device as claimed in claim 1, wherein the additional weld, preferably by laser welding, joins at least the edges of at least one plate to the other plate.

8. A method for assembling two plates in order to obtain a thermal regulation device, in particular a cooling device, for an electrical component that is liable to release heat during operation, in particular for an electrical energy storage module, the method being wherein it comprises the following steps,
providing two plates, each delimited by edges, at least one of the plates being pressed in order to form a portion of the walls of the channels, in such a way as to form, together with the other plate, a plurality of circulation channels for a heat transfer fluid, in particular a refrigerant fluid, the plurality of channels defining a channel zone,
transmission laser welding the two plates at the walls between the channels in contact with the second plate to form the channel zone,
then joining the perimeter of the channel zone of one plate to the other plate by an assembly means different from transmission laser welding, preferably by joining at least one channel wall defining said perimeter.

9. The assembly method as claimed in claim 8, which further comprises a third step of joining, by an additional weld, preferably by laser welding, surrounding the join of the perimeter of the channel zone by the different assembly means, in particular in such a way as to weld edges of at least one of the two plates to the other plate, preferably by laser welding.

10. The assembly method as claimed in claim 8, which further comprises a step of introducing glue that forms a seal in a pressed channel wall defining the entire perimeter of the channel zone and forming a sealing channel, in such a way that the glue is compressed by the two plates during their assembly, in particular followed by a step of heat treating the glue in the pressed wall once the plates of the device have been assembled and said glue has been compressed.

11. The thermal regulation device as claimed in claim 2, wherein the perimeter of the channel zone, preferably the at least one channel wall defining at least a portion of the perimeter of the channel zone, comprises a weld formed by friction stir welding.

12. The thermal regulation device as claimed in claim 2, wherein the perimeter of the channel zone, preferably the at least one channel wall defining at least a portion of the perimeter of the channel zone, comprises an adhesively bonded join.

13. The thermal regulation device as claimed in claim 2, wherein the perimeter of the channel zone, preferably the at least one pressed channel wall defining at least a portion of the perimeter of the channel zone, defines the entire perimeter of the channel zone and forms a sealing channel, the sealing channel comprising glue forming a seal.

14. The thermal regulation device as claimed in claim 2, wherein the device comprises an additional weld, preferably by laser welding, bordering the outer side of the join of the perimeter of the channel zone by the different assembly means.

15. The thermal regulation device as claimed in claim 2, wherein the additional weld, preferably by laser welding, joins at least the edges of at least one plate to the other plate.

16. The assembly method as claimed in claim 9, which further comprises a step of introducing glue that forms a seal in a pressed channel wall defining the entire perimeter of the channel zone and forming a sealing channel, in such a way that the glue is compressed by the two plates during their assembly, in particular followed by a step of heat treating the glue in the pressed wall once the plates of the device have been assembled and said glue has been compressed.

17. The thermal regulation device as claimed in claim 3, wherein the perimeter of the channel zone, preferably the at least one channel wall defining at least a portion of the perimeter of the channel zone, comprises an adhesively bonded join.

18. The thermal regulation device as claimed in claim 3, wherein the perimeter of the channel zone, preferably the at least one pressed channel wall defining at least a portion of the perimeter of the channel zone, defines the entire perimeter of the channel zone and forms a sealing channel, the sealing channel comprising glue forming a seal.

19. The thermal regulation device as claimed in claim 3, wherein the device comprises an additional weld, preferably by laser welding, bordering the outer side of the join of the perimeter of the channel zone by the different assembly means.

20. The thermal regulation device as claimed in claim 3, wherein the additional weld, preferably by laser welding, joins at least the edges of at least one plate to the other plate.
